(19) United States
(12) Patent Application Publication
(10) Pub. No.: US 2016/0196786 A1
(43) Pub. Date: Jul. 7, 2016

(54) GAMMA DIFFERENCE COMPENSATING APPARATUS, METHOD OF COMPENSATING GAMMA DIFFERENCE USING THE GAMMA DIFFERENCE COMPENSATING APPARATUS, AND DISPLAY SYSTEM INCLUDING THE GAMMA DIFFERENCE COMPENSATING APPARATUS

(71) Applicant: Samsung Display Co., LTD., Yongin-City (KR)

(72) Inventors: Kang-Hyun KIM, Seoul (KR); Hoi-Sik MOON, Asan-si (KR); Jong-Hee NA, Asan-si (KR); Woo-Jin JUNG, Seoul (KR); Jae-Seob CHUNG, Asan-si (KR)

(21) Appl. No.: 14/697,902

(22) Filed: Apr. 28, 2015

(30) Foreign Application Priority Data
Jan. 2, 2015 (KR) 10-2015-0000145

(51) Int. Cl. G09G 3/36; G09G 5/10

(52) U.S. Cl. CPC G09G 3/36; G09G 5/10; G09G 2320/0626; G09G 2310/08

(57) ABSTRACT

A gamma difference compensating apparatus includes a first gamma curve generating part, a front luminance measuring part, a front gamma calculating part, a second gamma curve generating part and a gamma compensating part. The first gamma curve generating part outputs a first gamma curve data. The front luminance measuring part measures a luminance of a left area from a front of the left area, measure a luminance of a right area from a front of the right area, and output a front luminance data. The front gamma calculating part outputs a front gamma data based on the front luminance data. The second gamma curve generating part applies the front gamma data to the first gamma data and output a second gamma curve data. The gamma compensating part compensates a gamma value of the left area and a gamma value of the right area.

### CLAIM OF PRIORITY

This application claims the priority of and all the benefits accruing under 35 U.S.C. §119 to Korean Patent Application No. 10-2015-0000145, filed on Jan. 2, 2015 in the Korean Intellectual Property Office (KIPO), the contents of which are herein incorporated by reference in their entireties.

### BACKGROUND OF THE INVENTION

1. Field of the Invention

Exemplary embodiments of the present inventive concept relate to a gamma difference compensating apparatus, a method of compensating a gamma difference using the gamma difference compensating apparatus, and a display system including the gamma difference compensating apparatus. More particularly, exemplary embodiments of the present inventive concept relate to a gamma difference compensating apparatus compensating a gamma difference of an image displayed on a display panel, a method of compensating a gamma difference using the gamma difference compensating apparatus, and a display system including the gamma difference compensating apparatus.

2. Description of the Related Art

A display apparatus such as a liquid crystal display apparatus, organic light emitting display (OLED) apparatus, plasma display device, or flexible display device, etc. includes a display panel and a display panel driving apparatus.

The display panel displays an image, and includes a gate line extending in a first direction, a data line extending in a second direction substantially perpendicular to the first direction, and a pixel defined by the gate line and the data line.

The display panel driving apparatus drives the display panel, and includes a gate driving part outputting a gate signal to the gate line, and a data driving part outputting a data signal to the data line.

After the display apparatus is manufactured, an inspection process of the image displayed on the display panel is performed. A luminance of the image may be not uniform while the display panel is inspected. In addition, a gamma value may be different according to a position on the display panel. Thus, display quality of the display panel may be degraded.

### SUMMARY OF THE INVENTION

Exemplary embodiments of the present inventive concept provide a gamma difference compensating apparatus capable of improving display quality of a display apparatus.

Exemplary embodiments of the present inventive concept also provide a method of compensating a gamma difference using the above-mentioned gamma difference compensating apparatus.

Exemplary embodiments of the present inventive concept also provide a display system including the above-mentioned gamma difference compensating apparatus.

According to an exemplary embodiment of the present inventive concept, a gamma difference compensating apparatus includes a photographing part, an average luminance calculating part, a first gamma curve generating part, a front luminance measuring part, a front gamma calculating part, a second gamma curve generating part and a gamma compensating part. The photographing part is configured to photograph an image displayed on a display panel and output a photograph data. The average luminance calculating part is configured to output an average luminance data of the image based on the photograph data. The first gamma curve generating part is configured to output a first gamma curve data of the image based on the average luminance data. The front luminance measuring part is configured to measure a luminance of a left area from a front of the left area disposed at a left side compared to a center area of the display panel, measure a luminance of a right area from a front of the right area disposed at a right side compared to the center area of the display panel, and output a front luminance data. The front gamma calculating part is configured to output a front gamma data based on the front luminance data. The second gamma curve generating part is configured to apply the front gamma data to the first gamma data and output a second gamma curve data. The gamma compensating part is configured to compensate a gamma value of the left area and a gamma value of the right area such that the gamma value of the left area is the same as a gamma value of the center area and the gamma value of the right area is the same as the gamma value of the center area.

In an exemplary embodiment, the second gamma curve generating part may include an offset gamma calculating part and a gamma curve generating part. The offset gamma calculating part may be configured to calculate a difference between a first gamma value of the left area included in the first gamma curve data and a front gamma value of the left area included in the front gamma data, calculate a difference between a first gamma value of the right area included in the first gamma curve data and a front gamma value of the right area included in the front gamma data, and output an offset gamma data. The gamma curve generating part may be configured to apply the offset gamma data to the first gamma curve data and output the second gamma curve data.

In an exemplary embodiment, the photographing part may photograph the center area including a middle center area focused by the photographing part, an upper center area adjacent to an upper side of the display panel compared to the middle center area and a lower center area adjacent to a lower side of the display panel compared to the middle center area, the left area including a middle left area adjacent to a left side of the display panel compared to the middle center area, an upper left area adjacent to the left side of the display panel compared to the upper center area and a lower left area adjacent to the left side of the display panel compared to the lower center area, and a middle right area adjacent to a right side of the display panel compared to the middle center area, an upper right area adjacent to the right side of the display panel compared to the upper center area and a lower right area adjacent to the right side of the display panel compared to the lower center area.

In an exemplary embodiment, the first gamma curve generating part may output a first middle center gamma value of the middle center area, a first upper center gamma value of the upper center area, a first lower center gamma value of the lower center area, a first middle left gamma value of the middle left area, a first upper left gamma value of the upper left area, a first lower left gamma value of the lower left area, a first middle right gamma value of the middle right area, a first upper right gamma value of the upper right area and a first lower right gamma value of the lower right area.

In an exemplary embodiment, the front luminance measuring part may output a middle left front luminance value of the middle left area, an upper left front luminance value of the upper left area, a lower left front luminance value of the lower left area, a middle right front luminance value of the middle right area, an upper right front luminance value of the upper right area and a lower right front luminance value of the lower right area.

In an exemplary embodiment, the front gamma calculating part may output a middle left front gamma value of the middle left area, an upper left front gamma value of the upper left area, a lower left front gamma value of the lower left area, a middle right front gamma value of the middle right area, an upper right front gamma value of the upper right area and a lower right front gamma value of the lower right area.

In an exemplary embodiment, the offset gamma calculating part may calculate a difference between the first middle left gamma value of the middle left area and the middle left front gamma value of the middle left area to output a middle left offset gamma value of the middle left area, may calculate a difference between the first upper left gamma value of the upper left area and the upper left front gamma value of the upper left area to output an upper left offset gamma value of the upper left area, may calculate a difference between the first lower left gamma value of the lower left area and the lower left front gamma value of the lower left area to output a lower left offset gamma value of the lower left area, may calculate a difference between the first middle right gamma value of the middle right area and the middle right front gamma value of the middle right area to output a middle right offset gamma value of the middle right area, may calculate a difference between the first upper right gamma value of the upper right area and the upper right front gamma value of the upper right area to output an upper right offset gamma value of the upper right area, and may calculate a difference between the first lower right gamma value of the lower right area and the lower right front gamma value of the lower right area to output a lower right offset gamma value of the lower right area.

In an exemplary embodiment, the second gamma curve generating part may apply the middle left offset gamma value of the middle left area to the first middle left gamma value of the middle left area to output a second middle left gamma value of the middle left area, may apply the upper left offset gamma value of the upper left area to the first upper left gamma value of the upper left area to output a second upper left gamma value of the upper left area, may apply the lower left offset gamma value of the lower left area to the first lower left gamma value of the lower left area to output a second lower left gamma value of the lower left area, may apply the middle right offset gamma value of the middle right area to the first middle right gamma value of the middle right area to output a second middle right gamma value of the middle right area, may apply the upper right offset gamma value of the upper right area to the first upper right gamma value of the upper right area to output a second upper right gamma value of the upper right area, and may apply the lower right offset gamma value of the lower right area to the first lower right gamma value of the lower right area to output a second lower right gamma value of the lower right area.

In an exemplary embodiment, the gamma compensating part may compensate the second middle left gamma value of the middle left area such that the second middle left gamma value of the middle left area is the same as the first middle center gamma value of the middle center area, may compensate the second upper left gamma value of the upper left area such that the second upper left gamma value of the upper left area is the same as the first upper center gamma value of the upper center area, may compensate the second lower left gamma value of the lower left area such that the second lower left gamma value of the lower left area is the same as the first lower center gamma value of the lower center area, may compensate the second middle right gamma value of the middle right area such that the second middle right gamma value of the middle right area is the same as the first middle center gamma value of the middle center area, may compensate the second upper right gamma value of the upper right area such that the second upper right gamma value of the upper right area is the same as the first upper center gamma value of the upper center area, and may compensate the second lower right gamma value of the lower right area such that the second lower right gamma value of the lower right area is the same as the first lower center gamma value of the lower center area.

According to an exemplary embodiment of the present inventive concept, a method of compensating a gamma difference includes photographing an image displayed on a display panel to output a photograph data, outputting an average luminance data of the image based on the photograph data, outputting a first gamma curve data of the image based on the average luminance data, measuring a luminance of a left area from a front of the left area disposed at a left side compared to a center area of the display panel and measuring a luminance of a right area from a front of the right area disposed at a right side compared to the center area of the display panel to output a front luminance data, outputting a front gamma data based on the front luminance data, applying the front gamma data to the first gamma data to output a second gamma curve data, and compensating a gamma value of the left area and a gamma value of the right area such that the gamma value of the left area is the same as a gamma value of the center area and the gamma value of the right area is the same as the gamma value of the center area.

In an exemplary embodiment, the generating the second gamma curve data may include calculating a difference between a first gamma value of the left area included in the first gamma curve data and a front gamma value of the left area included in the front gamma data and calculating a difference between a first gamma value of the right area included in the first gamma curve data and a front gamma value of the right area included in the front gamma data to output an offset gamma data, and applying the offset gamma data to the first gamma curve data to output the second gamma curve data.

In an exemplary embodiment, the photographing the image may include photographing the center area including a middle center area focused by a photographing part, an upper center area adjacent to an upper side of the display panel compared to the middle center area and a lower center area adjacent to a lower side of the display panel compared to the middle center area, the left area including a middle left area adjacent to a left side of the display panel compared to the middle center area, an upper left area adjacent to the left side of the display panel compared to the upper center area and a lower left area adjacent to the left side of the display panel compared to the lower center area, and a middle right area adjacent to a right side of the display panel compared to the middle center area, an upper right area adjacent to the right side of the display panel compared to the upper center area and a lower right area adjacent to the right side of the display panel compared to the lower center area, using the photographing part.

In an exemplary embodiment, the outputting the first gamma curve data may include outputting a first middle center gamma value of the middle center area, outputting a first upper center gamma value of the upper center area, outputting a first lower center gamma value of the lower center area, outputting a first middle left gamma value of the middle left area, outputting a first upper left gamma value of the upper left area, outputting a first lower left gamma value of the lower left area, outputting a first middle right gamma value of the middle right area, outputting a first upper right gamma value of the upper right area, and outputting a first lower right gamma value of the lower right area.

In an exemplary embodiment, the outputting the front luminance data may include outputting an upper left front luminance value of the upper left area, outputting a lower left front luminance value of the lower left area, outputting a middle right front luminance value of the middle right area, outputting an upper right front luminance value of the upper right area, and outputting a lower right front luminance value of the lower right area.

In an exemplary embodiment, the outputting the front gamma data may include outputting a middle left front gamma value of the middle left area, outputting an upper left front gamma value of the upper left area, outputting a lower left front gamma value of the lower left area, outputting a middle right front gamma value of the middle right area, outputting an upper right front gamma value of the upper right area, and outputting a lower right front gamma value of the lower right area.

In an exemplary embodiment, the outputting the offset gamma data may include calculating a difference between the first middle left gamma value of the middle left area and the middle left front gamma value of the middle left area to output a middle left offset gamma value of the middle left area, calculating a difference between the first upper left gamma value of the upper left area and the upper left front gamma value of the upper left area to output an upper left offset gamma value of the upper left area, calculating a difference between the first lower left gamma value of the lower left area and the lower left front gamma value of the lower left area to output a lower left offset gamma value of the lower left area, calculating a difference between the first middle right gamma value of the middle right area and the middle right front gamma value of the middle right area to output a middle right offset gamma value of the middle right area, calculating a difference between the first upper right gamma value of the upper right area and the upper right front gamma value of the upper right area to output an upper right offset gamma value of the upper right area, and calculating a difference between the first lower right gamma value of the lower right area and the lower right front gamma value of the lower right area to output a lower right offset gamma value of the lower right area.

In an exemplary embodiment, the outputting the second gamma curve data may include applying the middle left offset gamma value of the middle left area to the first middle left gamma value of the middle left area to output a second middle left gamma value of the middle left area, applying the upper left offset gamma value of the upper left area to the first upper left gamma value of the upper left area to output a second upper left gamma value of the upper left area, applying the lower left offset gamma value of the lower left area to the first lower left gamma value of the lower left area to output a second lower left gamma value of the lower left area, applying the middle right offset gamma value of the middle right area to the first middle right gamma value of the middle right area to output a second middle right gamma value of the middle right area, applying the upper right offset gamma value of the upper right area to the first upper right gamma value of the upper right area to output a second upper right gamma value of the upper right area, and applying the lower right offset gamma value of the lower right area to the first lower right gamma value of the lower right area to output a second lower right gamma value of the lower right area.

In an exemplary embodiment, the compensating the gamma value may include compensating the second middle left gamma value of the middle left area such that the second middle left gamma value of the middle left area is the same as the first middle center gamma value of the middle center area, compensating the second upper left gamma value of the upper left area such that the second upper left gamma value of the upper left area is the same as the first upper center gamma value of the upper center area, compensating the second lower left gamma value of the lower left area such that the second lower left gamma value of the lower left area is the same as the first lower center gamma value of the lower center area, compensating the second middle right gamma value of the middle right area such that the second middle right gamma value of the middle right area is the same as the first middle center gamma value of the middle center area, compensating the second upper right gamma value of the upper right area such that the second upper right gamma value of the upper right area is the same as the first upper center gamma value of the upper center area, and compensating the second lower right gamma value of the lower right area such that the second lower right gamma value of the lower right area is the same as the first lower center gamma value of the lower center area.

According to an exemplary embodiment of the present inventive concept, a display system includes a display apparatus and a compensating apparatus. The display apparatus includes a display panel including a gate line and a data line and displaying an image, a gate driving part outputting a gate signal to the gate line, and a data driving part outputting a data signal to the data line. The compensating apparatus includes a photographing part photographing the image displayed on the display panel to output a photograph data, an average luminance calculating part outputting an average luminance data of the image based on the photograph data, a first gamma curve generating part outputting a first gamma curve data of the image based on the average luminance data, a front luminance measuring part measuring a luminance of a left area from a front of the left area disposed at a left side compared to a center area of the display panel and measuring a luminance of a right area from a front of the right area disposed at a right side compared to the center area of the display panel to output a front luminance data, a front gamma calculating part outputting a front gamma data based on the front luminance data, a second gamma curve generating part applying the front gamma data to the first gamma data to output a second gamma curve data, and a gamma compensating part compensating a gamma value of the left area and a gamma value of the right area such that the gamma value of the left area is the same as a gamma value of the center area and the gamma value of the right area is the same as the gamma value of the center area.

In an exemplary embodiment, the compensating apparatus may further compensate a spot defect of the image.

According to the present inventive concept, after photographing an image displayed on a display panel using one camera, a gamma difference and a spot defect of the image may be compensated. Therefore, a luminance uniformity of the display panel may be increased, display quality of a display apparatus including the display panel may be improved, and a manufacturing cost of an inspection apparatus inspecting the display apparatus may be decreased.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a block diagram illustrating a gamma difference compensating apparatus according to an exemplary embodiment of the present inventive concept;

FIG. 2 is a plan view illustrating a display panel photographed by a photographing part of FIG. 1;

FIG. 3 is a block diagram illustrating a second gamma curve generating part of FIG. 1;

FIGS. 4A and 4B are flow charts illustrating a method of compensating a gamma difference performed by the gamma difference compensating apparatus of FIG. 1; and

FIG. 5 is a block diagram illustrating a display system according to an exemplary embodiment of the present inventive concept.

### DETAILED DESCRIPTION OF THE INVENTION

Hereinafter, the present inventive concept will be explained in detail with reference to the accompanying drawings.

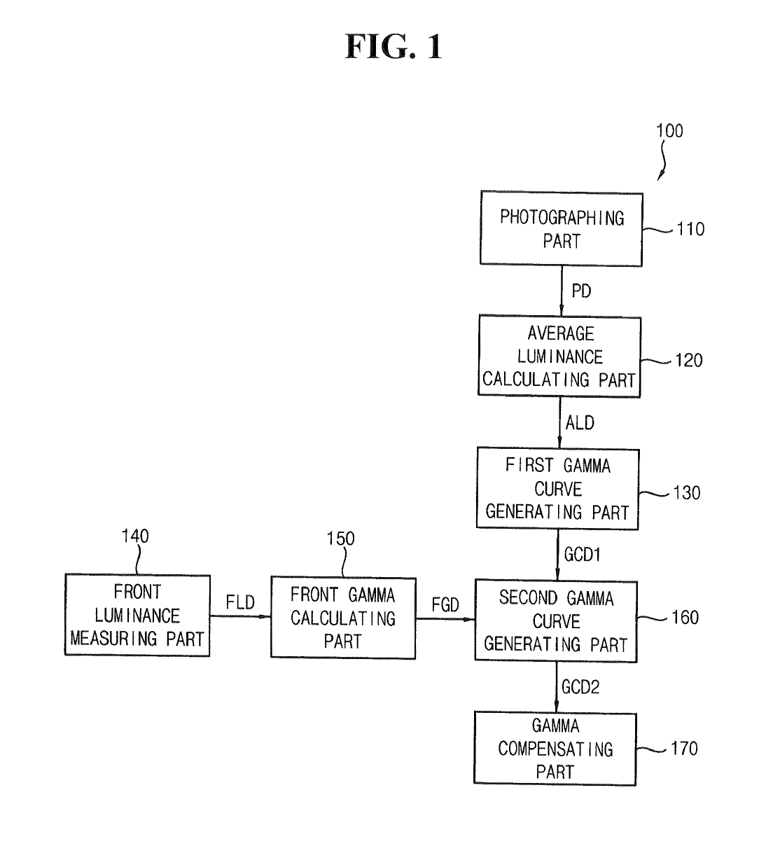

FIG. 1 is a block diagram illustrating a gamma difference compensating apparatus according to an exemplary embodiment of the present inventive concept.

Referring to FIG. 1, the gamma difference compensating apparatus 100 according to the present exemplary embodiment includes a photographing part 110, an average luminance calculating part 120, a first gamma curve generating part 130, a front luminance measuring part 140, a front gamma calculating part 150, a second gamma curve generating part 160 and a gamma compensating part 170. The gamma difference compensating apparatus 100 may be an inspecting apparatus which inspects an image displayed on a display panel, and may be a compensating apparatus which compensates the image.

The photographing part 110 photographs the image displayed on the display panel and outputs a photograph data PD. For example, the photographing part 110 may include one camera, and the camera may be a Charge Coupled Device (CCD) camera.

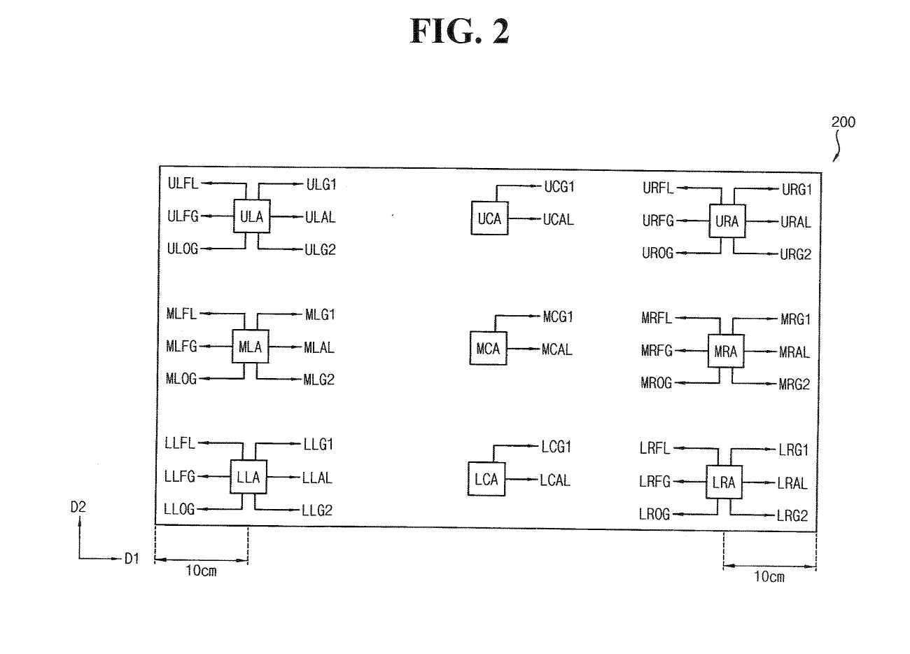

FIG. 2 is a plan view illustrating the display panel photographed by the photographing part 110.

Referring to FIGS. 1 and 2, the display panel 200 may include an upper left area ULA, a middle left area MLA, a lower left area LLA, an upper center area UCA, a middle center area MCA, a lower center area LCA, an upper right area URA, a middle right area MRA and a lower right area LRA.

The middle center area MCA is disposed at a center of the display panel 200. The middle center area MCA may be focused by the photographing part 200. The upper center area UCA is adjacent to an upper side of the display panel 200 compared to the middle center area MCA. The lower center area LCA is adjacent to a lower side of the display panel 200 compared to the middle center area MCA. The upper left area ULA is adjacent to the left side of the display panel 200 compared to the upper center area UCA. The middle left area MLA is adjacent to the left side of the display panel 200 compared to the middle center area MCA. The lower left area LLA is adjacent to the left side of the display panel 200 compared to the lower center area LCA. The upper right area URA is adjacent to a right side of the display panel 200 compared to the upper center area UCA. The middle right area MRA is adjacent to the right side of the display panel 200 compared to the middle center area MCA. The lower right area LRA is adjacent to the right side of the display panel 200 compared to the lower center area LCA.

The upper left area ULA, the middle left area MLA and the lower left area LLA may be defined as a left area. The upper right area URA, the middle right area MRA and the lower right area LRA may be defined as a right area. The upper center area UCA, the middle center area MCA and the lower center area LCA may be defined as a center area.

For example, the upper left area ULA, the middle left area MLA and the lower left area LLA may be spaced apart from a left edge of the display panel 200 by about 10 cm. In addition, the upper right area URA, the middle right area MRA and the lower right area LRA may be spaced apart from a right edge of the display panel 200 by about 10 cm. In addition, the upper left area ULA, the upper center area UCA and the upper right area URA may be disposed at a point corresponding to ⅙ of a width of the display panel 200 from an upper edge of the display panel 200. In addition, the middle left area MLA, the middle center area MCA and the middle right area MRA may be disposed at a point corresponding to a half of the width of the display panel 200 from the upper edge of the display panel 200. In addition, the lower left area LLA, the lower center area LCA and the lower right area LRA may be disposed at a point corresponding to ⅚ of a width of the display panel 200 from the upper edge of the display panel 200.

Each of the upper left area ULA, the middle left area MLA, the lower left area LLA, the upper center area UCA, the middle center area MCA, the lower center area LCA, the upper right area URA, the middle right area MRA and the lower right area LRA may include a plurality of pixels. For example, each of the upper left area ULA, the middle left area MLA, the lower left area LLA, the upper center area UCA, the middle center area MCA, the lower center area LCA, the upper right area URA, the middle right area MRA and the lower right area LRA may include 100 pixels in a first direction D1 and may include 100 pixels in a second direction D2 substantially perpendicular to the first direction D1.

The average luminance calculating part 120 calculates an average luminance of an image corresponding to each of the upper left area ULA, the middle left area MLA, the lower left area LLA, the upper center area UCA, the middle center area MCA, the lower center area LCA, the upper right area URA, the middle right area MRA and the lower right area LRA based on the photograph data PD, and outputs an average luminance data ALD.

Specifically, the average luminance calculating part 120 outputs an upper left average luminance value ULAL of the upper left area ULA, outputs a middle left average luminance value MLAL of the middle left area MLA, and outputs a lower left average luminance value LLAL of the lower left area LLA. In addition, the average luminance calculating part 120 outputs an upper center average luminance value UCAL of the upper center area UCA, outputs a middle center average luminance value MCAL of the middle center area MCA, and outputs a lower center average luminance value LCAL of the lower center area LCA. In addition, the average luminance calculating part 120 outputs an upper right average luminance value URAL of the upper right area URA, outputs a middle right average luminance value MRAL of the middle right area MRA, and outputs a lower right average luminance value LRAL of the lower right area LRA.

For example, the average luminance calculating part 120 outputs the upper left average luminance value ULAL of the upper left area ULA, the middle left average luminance value MLAL of the middle left area MLA, the lower left average luminance value LLAL of the lower left area LLA, the upper center average luminance value UCAL of the upper center area UCA, the middle center average luminance value MCAL of the middle center area MCA, the lower center average luminance value LCAL of the lower center area LCA, the upper right average luminance value URAL of the upper right area URA, the middle right average luminance value MRAL of the middle right area MRA, and the lower right average luminance value LRAL of the lower right area LRA correspondingly to representative sample grayscales. For example, the representative sample grayscales may include 0 grayscale, 16 grayscale, 24 grayscale, 32 grayscale, 64 grayscale, 96 grayscale, 128 grayscale, 192 grayscale and 255 grayscale.

The first gamma curve generating part 130 outputs a first gamma curve data GCD1 of the image based on the average luminance data ALD. The first gamma curve generating part 130 outputs a first gamma curve data of each of the upper left area ULA, the middle left area MLA, the lower left area LLA, the upper center area UCA, the middle center area MCA, the lower center area LCA, the upper right area URA, the middle right area MRA and the lower right area LRA using an average luminance value of the representative sample grayscales, which is included in the average luminance data and an interpolation method between the representative sample grayscales.

Specifically, the first gamma curve generating part 130 outputs a first upper left gamma value ULG1 of the upper left area ULA, outputs a first middle left gamma value MLG1 of the middle left area MLA, and outputs a first lower left gamma value LLG1 of the lower left area LLA. In addition, the first gamma curve generating part 130 outputs a first upper center gamma value UCG1 of the upper center area UCA, outputs a first middle center gamma value MCG1 of the middle center area MCA, and outputs a first lower center gamma value LCG1 of the lower center area LCA. In addition, the first gamma curve generating part 130 outputs a first upper right gamma value URG1 of the upper right area URA, outputs a first middle right gamma value MRG1 of the middle right area MRA, and outputs a first lower right gamma value LRG1 of the lower right area LRA.

The front luminance measuring part 140 measures a luminance of the left area and measures a luminance of the right area to output a front luminance data FLD. Specifically, the front luminance measuring part 140 measures a luminance of the upper left area ULA from a front of the upper left area ULA to output an upper left front luminance value ULFL, measures a luminance of the middle left area MLA from a front of the middle left area MLA to output a middle left front luminance value MLFL, and measures a luminance of the lower left area LLA from a front of the lower left area LLA to output a lower left front luminance value LLFL. In addition, the front luminance measuring part 140 measures a luminance of the upper right area URA from a front of the upper right area URA to output an upper right front luminance value URFL, measures a luminance of the middle right area MRA from a front of the middle right area MRA to output a middle right front luminance value MRFL, and measures a luminance of the lower right area LRA from a front of the lower right area LRA to output a lower right front luminance value LRFL.

The front gamma calculating part 150 outputs a front gamma data FGD based on the front luminance data FLD. Specifically, the front gamma calculating part 150 outputs an upper left front gamma value ULFG of the upper left area ULA based on the upper left front luminance value ULFL of the upper left area ULA, outputs a middle left front gamma value MLFG of the middle left area MLA based on the middle left front luminance value MLFL of the middle left area MLA, and outputs a lower left front gamma value LLFG of the lower left area LLA based on the lower left front luminance value LLFL of the lower left area LLA. In addition, the front gamma calculating part 150 outputs an upper right front gamma value URFG of the upper right area URA based on the upper right front luminance value URFL of the upper right area URA, outputs a middle right front gamma value MRFG of the middle right area MRA based on the middle right front luminance value MRFL of the middle right area MRA, and outputs a lower right front gamma value LRFG of the lower right area LRA based on the lower right front luminance value LRFL of the lower right area LRA.

The second gamma curve generating part 160 applies the front gamma data FGD to the first gamma curve data GCD1 and outputs a second gamma curve data GCD2.

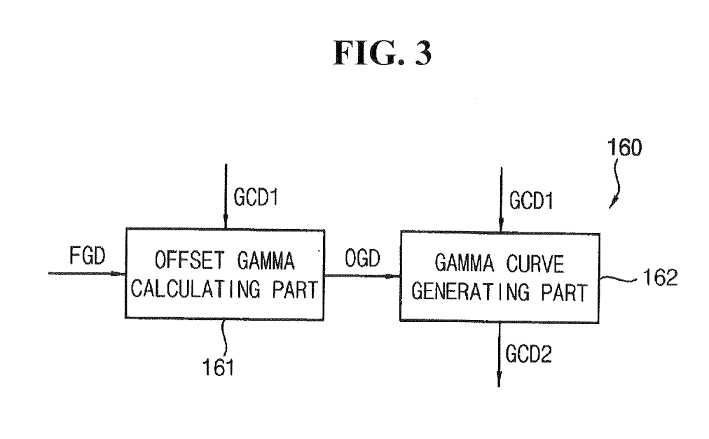

FIG. 3 is a block diagram illustrating the second gamma curve generating part 160 of FIG. 1.

Referring to FIGS. 1 to 3, the second gamma curve generating part 160 includes an offset gamma calculating part 161 and a gamma curve generating part 162.

The offset gamma calculating part 161 calculates a difference between a first gamma value of the left area included in the first gamma curve data GCD1 and a front gamma value of the left area included in the front gamma data FGD and calculates a difference between a first gamma value of the right area included in the first gamma curve data GCD1 and a front gamma value of the right area included in the front gamma data FGD to output an offset gamma data OGD.

Specifically, the offset gamma calculating part 161 calculates a difference between the first upper left gamma value ULG1 of the upper left area ULA and the upper left front gamma value ULFG of the upper left area ULA to output an upper left offset gamma value ULOG of the upper left area ULA, calculates a difference between the first middle left gamma value MLG1 of the middle left area MLA and the middle left front gamma value MLFG of the middle left area MLA to output a middle left offset gamma value MLOG of the middle left area MLA, and calculates a difference between the first lower left gamma value LLG1 of the lower left area LLA and the lower left front gamma value LLFG of the lower left area LLA to output a lower left offset gamma value LLOG of the lower left area LLA. In addition, the offset gamma calculating part 161 calculates a difference between the first upper right gamma value URG1 of the upper right area URA and the upper right front gamma value URFG of the upper right area URA to output an upper right offset gamma value UROG of the upper right area URA, calculates a difference between the first middle right gamma value MRG1 of the middle right area MRA and the middle right front gamma value MRFG of the middle right area MRA to output a middle right offset gamma value MROG of the middle right area MRA, and calculates a difference between the first lower right gamma value LRG1 of the lower right area LRA and the lower right front gamma value LRFG of the lower right area LRA to output a lower right offset gamma value LROG of the lower right area LRA.

The gamma curve generating part 162 applies the offset gamma data OGD to the first gamma curve data GCD1 to output the second gamma curve data GCD2. A first gamma data of the left area is different from a real gamma data of the left area and a first gamma data of the right area is different from a real gamma data of the right area owing to at least one of a viewing angle of the photographing part 110, a vignetting effect of the photographing part 110 and characteristics of an liquid crystal in the display panel 200.

Thus, the gamma curve generating part 162 applies the upper left offset gamma value ULOG of the upper left area ULA to the first upper left gamma value ULG1 of the upper left area ULA to output a second upper left gamma value ULG2 of the upper left area ULA, applies the middle left offset gamma value MLOG of the middle left area MLA to the first middle left gamma value MLG1 of the middle left area MLA to output a second middle left gamma value MLG2 of the middle left area ULA, and applies the lower left offset gamma value LLOG of the lower left area LLA to the first lower left gamma value LLG1 of the lower left area LLA to output a second lower left gamma value LLG2 of the lower left area LLA. In addition, the gamma curve generating part 162 applies the upper right offset gamma value UROG of the upper right area URA to the first upper right gamma value URG1 of the upper right area URA to output a second upper right gamma value URG2 of the upper right area URA, applies the middle right offset gamma value MROG of the middle right area MRA to the first middle right gamma value MRG1 of the middle right area MRA to output a second middle right gamma value MRG2 of the middle right area URA, and applies the lower right offset gamma value LROG of the lower right area LRA to the first lower right gamma value LRG1 of the lower right area LRA to output a second lower right gamma value LRG2 of the lower right area LRA.

For example, the gamma curve generating part 162 may add the upper left offset gamma value ULOG of the upper left area ULA to the first upper left gamma value ULG1 of the upper left area ULA to output the second upper left gamma value ULG2 of the upper left area ULA, may add the middle left offset gamma value MLOG of the middle left area MLA to the first middle left gamma value MLG1 of the middle left area MLA to output the second middle left gamma value MLG2 of the middle left area ULA, and may add the lower left offset gamma value LLOG of the lower left area LLA to the first lower left gamma value LLG1 of the lower left area LLA to output the second lower left gamma value LLG2 of the lower left area LLA. In addition, the gamma curve generating part 162 may add the upper right offset gamma value UROG of the upper right area URA to the first upper right gamma value URG1 of the upper right area URA to output the second upper right gamma value URG2 of the upper right area URA, may add the middle right offset gamma value MROG of the middle right area MRA to the first middle right gamma value MRG1 of the middle right area MRA to output the second middle right gamma value MRG2 of the middle right area URA, and may add the lower right offset gamma value LROG of the lower right area LRA to the first lower right gamma value LRG1 of the lower right area LRA to output the second lower right gamma value LRG2 of the lower right area LRA.

The gamma compensating part 170 compensates a gamma value of the left area such that the gamma value of the left area is substantially the same as a gamma value of the center area. In addition, the gamma compensating part 170 compensates a gamma value of the right area such that the gamma value of the right area is substantially the same as the gamma value of the center area.

Specifically, the gamma compensating part 170 compensates the second upper left gamma value ULG2 of the upper left area ULA such that the second upper left gamma value ULG2 of the upper left area ULA is substantially the same as the first upper center gamma value UCG1 of the upper center area UCA, compensates the second middle left gamma value MLG2 of the middle left area MLA such that the second middle left gamma value MLG2 of the middle left area MLA is substantially the same as the first middle center gamma value MCG1 of the middle center area MCA, and compensates the second lower left gamma value LLG2 of the lower left area LLA such that the second lower left gamma value LLG2 of the lower left area LLA is substantially the same as the first lower center gamma value LCG1 of the lower center area MCA. In addition, the gamma compensating part 170 compensates the second upper right gamma value URG2 of the upper right area URA such that the second upper right gamma value URG2 of the upper right area URA is substantially the same as the first upper center gamma value UCG1 of the upper center area UCA, compensates the second middle right gamma value MRG2 of the middle right area MRA such that the second middle right gamma value MRG2 of the middle right area MRA is substantially the same as the first middle center gamma value MCG1 of the middle center area MCA, and compensates the second lower right gamma value LRG2 of the lower right area LRA such that the second lower right gamma value LRG2 of the lower right area LRA is substantially the same as the first lower center gamma value LCG1 of the lower center area MCA.

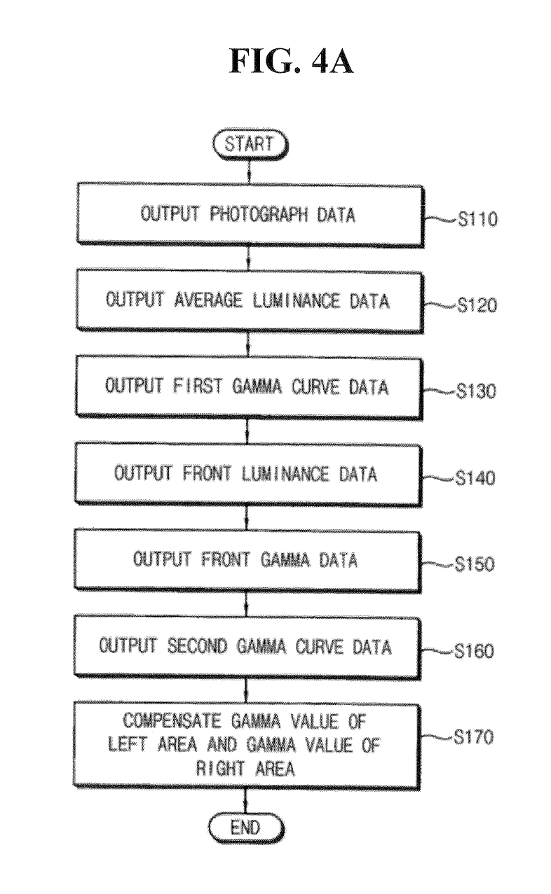

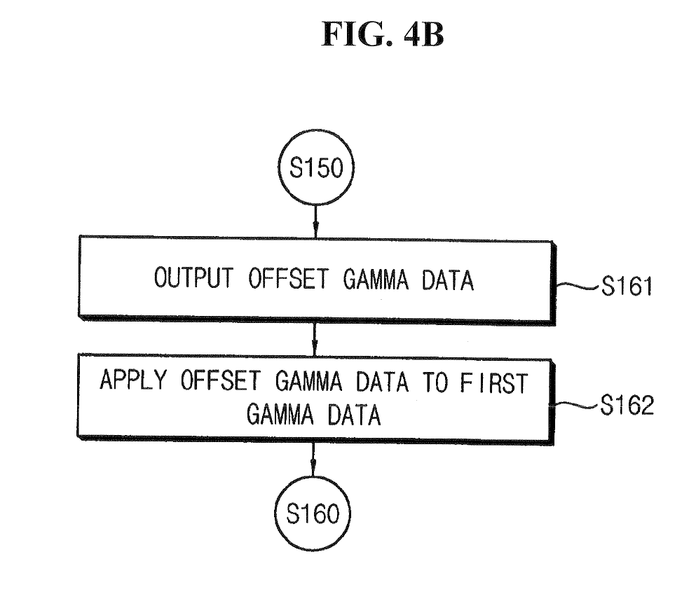

FIGS. 4A and 4B are flow charts illustrating a method of compensating a gamma difference performed by the gamma difference compensating apparatus 100 of FIG. 1.

Referring to FIGS. 1 to 4B, the photograph data PD is output (step S110). Specifically, the photographing part 110 photographs the image displayed on the display panel 200 and outputs the photograph data PD.

The average luminance data ALD is output (step S120). Specifically, the average luminance calculating part 120 outputs the upper left average luminance value ULAL of the upper left area ULA, the middle left average luminance value MLAL of the middle left area MLA, the lower left average luminance value LLAL of the lower left area LLA, the upper center average luminance value UCAL of the upper center area UCA, the middle center average luminance value MCAL of the middle center area MCA, the lower center average luminance value LCAL of the lower center area LCA, the upper right average luminance value URAL of the upper right area URA, the middle right average luminance value MRAL of the middle right area MRA and the lower right average luminance value LRAL of the lower right area LRA, based on the photograph data PD.

The first gamma curve data GCD1 is output (step S130). Specifically, the first gamma curve generating part 130 outputs the first upper left gamma value ULG1 of the upper left area ULA, the first middle left gamma value MLG1 of the middle left area MLA, the first lower left gamma value LLG1 of the lower left area LLA, the first upper center gamma value UCG1 of the upper center area UCA, the first middle center gamma value MCG1 of the middle center area MCA, the first lower center gamma value LCG1 of the lower center area LCA, the first upper right gamma value URG1 of the upper right area URA, the first middle right gamma value MRG1 of the middle right area MRA and the first lower right gamma value LRG1 of the lower right area LRA, based on the average luminance data ALD.

The front luminance data FLD is output (step S140). Specifically, the front luminance measuring part 140 measures the luminance of the upper left area ULA from the front of the upper left area ULA to output the upper left front luminance value ULFL, measures the luminance of the middle left area MLA from the front of the middle left area MLA to output the middle left front luminance value MLFL, and measures the luminance of the lower left area LLA from the front of the lower left area LLA to output the lower left front luminance value LLFL. In addition, the front luminance measuring part 140 measures the luminance of the upper right area URA from the front of the upper right area URA to output the upper right front luminance value URFL, measures the luminance of the middle right area MRA from the front of the middle right area MRA to output the middle right front luminance value MRFL, and measures the luminance of the lower right area LRA from the front of the lower right area LRA to output the lower right front luminance value LRFL.

The front gamma data FGD is output (step S150). Specifically, the front gamma calculating part 150 outputs the upper left front gamma value ULFG of the upper left area ULA based on the upper left front luminance value ULFL of the upper left area ULA, outputs the middle left front gamma value MLFG of the middle left area MLA based on the middle left front luminance value MLFL of the middle left area MLA, and outputs the lower left front gamma value LLFG of the lower left area LLA based on the lower left front luminance value LLFL of the lower left area LLA. In addition, the front gamma calculating part 150 outputs the upper right front gamma value URFG of the upper right area URA based on the upper right front luminance value URFL of the upper right area URA, outputs the middle right front gamma value MRFG of the middle right area MRA based on the middle right front luminance value MRFL of the middle right area MRA, and outputs the lower right front gamma value LRFG of the lower right area LRA based on the lower right front luminance value LRFL of the lower right area LRA.

The second gamma curve data GCD2 is output (step S160).

Specifically, the offset gamma data OGD is output (step S161). More specifically, the offset gamma calculating part 161 calculates the difference between the first upper left gamma value ULG1 of the upper left area ULA and the upper left front gamma value ULFG of the upper left area ULA to output the upper left offset gamma value ULOG of the upper left area ULA, calculates the difference between the first middle left gamma value MLG1 of the middle left area MLA and the middle left front gamma value MLFG of the middle left area MLA to output the middle left offset gamma value MLOG of the middle left area MLA, and calculates the difference between the first lower left gamma value LLG1 of the lower left area LLA and the lower left front gamma value LLFG of the lower left area LLA to output the lower left offset gamma value LLOG of the lower left area LLA. In addition, the offset gamma calculating part 161 calculates the difference between the first upper right gamma value URG1 of the upper right area URA and the upper right front gamma value URFG of the upper right area URA to output the upper right offset gamma value UROG of the upper right area URA, calculates the difference between the first middle right gamma value MRG1 of the middle right area MRA and the middle right front gamma value MRFG of the middle right area MRA to output the middle right offset gamma value MROG of the middle right area MRA, and calculates the difference between the first lower right gamma value LRG1 of the lower right area LRA and the lower right front gamma value LRFG of the lower right area LRA to output the lower right offset gamma value LROG of the lower right area LRA.

The offset gamma data OGD is applied to the first gamma curve data GCD1 (step S162). Specifically, the gamma curve generating part 162 applies the offset gamma data OGD to the first gamma curve data GCD1 to output the second gamma curve data GCD2. A first gamma data of the left area is different from a real gamma data of the left area and a first gamma data of the right area is different from a real gamma data of the right area owing to at least one of a viewing angle of the photographing part 110, a vignetting effect of the photographing part 110 and characteristics of an liquid crystal in the display panel 200

Thus, the gamma curve generating part 162 applies the upper left offset gamma value ULOG of the upper left area ULA to the first upper left gamma value ULG1 of the upper left area ULA to output the second upper left gamma value ULG2 of the upper left area ULA, applies the middle left offset gamma value MLOG of the middle left area MLA to the first middle left gamma value MLG1 of the middle left area MLA to output the second middle left gamma value MLG2 of the middle left area ULA, and applies the lower left offset gamma value LLOG of the lower left area LLA to the first lower left gamma value LLG1 of the lower left area LLA to output the second lower left gamma value LLG2 of the lower left area LLA. In addition, the gamma curve generating part 162 applies the upper right offset gamma value UROG of the upper right area URA to the first upper right gamma value URG1 of the upper right area URA to output the second upper right gamma value URG2 of the upper right area URA, applies the middle right offset gamma value MROG of the middle right area MRA to the first middle right gamma value MRG1 of the middle right area MRA to output the second middle right gamma value MRG2 of the middle right area URA, and applies the lower right offset gamma value LROG of the lower right area LRA to the first lower right gamma value LRG1 of the lower right area LRA to output the second lower right gamma value LRG2 of the lower right area LRA.

The gamma value of the left area and the gamma value of the right area are compensated (step S170). Specifically, the gamma compensating part 170 compensates the second upper left gamma value ULG2 of the upper left area ULA such that the second upper left gamma value ULG2 of the upper left area ULA is substantially the same as the first upper center gamma value UCG1 of the upper center area UCA, compensates the second middle left gamma value MLG2 of the middle left area MLA such that the second middle left gamma value MLG2 of the middle left area MLA is substantially the same as the first middle center gamma value MCG1 of the middle center area MCA, and compensates the second lower left gamma value LLG2 of the lower left area LLA such that the second lower left gamma value LLG2 of the lower left area LLA is substantially the same as the first lower center gamma value LCG1 of the lower center area MCA. In addition, the gamma compensating part 170 compensates the second upper right gamma value URG2 of the upper right area URA such that the second upper right gamma value URG2 of the upper right area URA is substantially the same as the first upper center gamma value UCG1 of the upper center area UCA, compensates the second middle right gamma value MRG2 of the middle right area MRA such that the second middle right gamma value MRG2 of the middle right area MRA is substantially the same as the first middle center gamma value MCG1 of the middle center area MCA, and compensates the second lower right gamma value LRG2 of the lower right area LRA such that the second lower right gamma value LRG2 of the lower right area LRA is substantially the same as the first lower center gamma value LCG1 of the lower center area MCA.

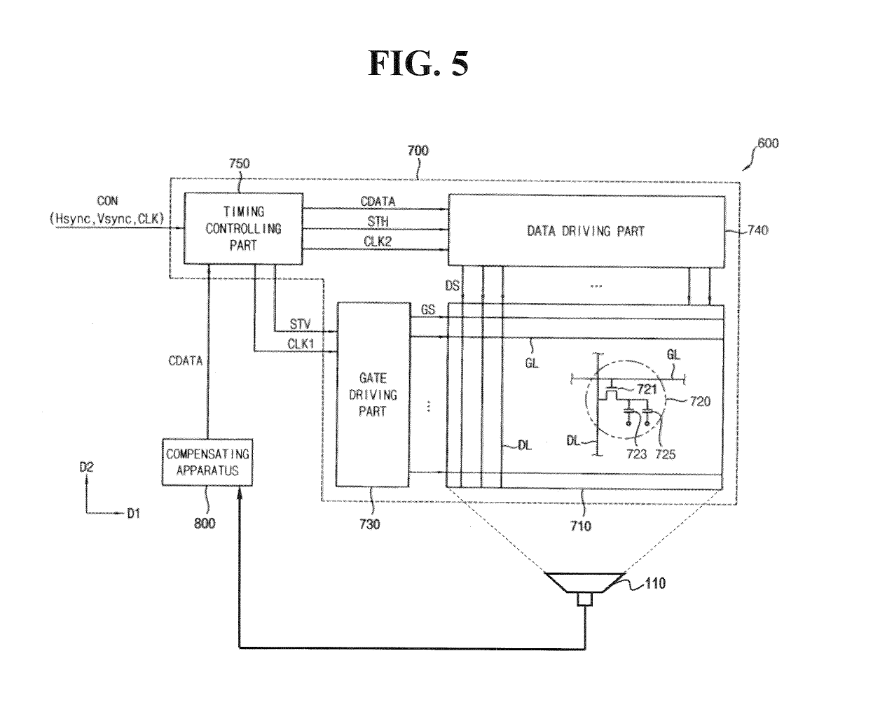

FIG. 5 is a block diagram illustrating a display system according to an exemplary embodiment of the present inventive concept.

Referring to FIG. 5, the display system 600 according to the present exemplary embodiment includes a display apparatus 700 and a compensating apparatus 800.

The display apparatus 700 includes a display panel 710, a gate driving part 730, a data driving part 740 and a timing controlling part 750.

The display panel 710 receives a data signal DS based on a compensated image data CDATA provided from the timing controlling part 750 to display an image. For example, the compensated image data CDATA may be a two-dimensional plane image data. Alternatively, the compensated image data CDATA may include a left-eye image data and a right-eye image data for displaying a three-dimensional stereoscopic image.

The display panel 710 includes gate lines GL, data lines DL and a plurality of pixels 720. The gate lines GL extend in a first direction D1 and are arranged in a second direction D2 substantially perpendicular to the first direction D1. The data lines DL extend in the second direction D2 and are arranged in the first direction D1. Each of the pixels 720 includes a thin film transistor 721 electrically connected to the gate line GL and the data line DL, a liquid crystal capacitor 723 and a storage capacitor 725 connected to the thin film transistor 721.

The gate driving part 730, the data driving part 740 and the timing controlling part 750 may be defined as a display panel driving apparatus driving the display panel 710.

The gate driving part 730 generates a gate signal GS in response to a gate start signal STV and a gate clock signal CLK1 provided from the timing controlling part 750, and outputs the gate signal GS to the gate line GL.

The data driving part 740 outputs the data signal DS to the data line DL in response to a data start signal STH and a data clock signal CLK2 provided from the timing controlling part 750.

The timing controlling part 750 receives the compensated image data CDATA from the compensating apparatus 800 and receives a control signal CON from an outside. The control signal CON may include a horizontal synchronous signal Hsync, a vertical synchronous signal Vsync and a clock signal CLK. The timing controlling part 750 generates the data start signal STH using the horizontal synchronous signal Hsync and outputs the data start signal STH to the data driving part 740. In addition, the timing controlling part 750 generates the gate start signal STV using the vertical synchronous signal Vsync and outputs the gate start signal STV to the gate driving part 730. In addition, the timing controlling part 750 generates the gate clock signal CLK1 and the data clock signal CLK2 using the clock signal CLK, outputs the gate clock signal CLK1 to the gate driving part 730, and outputs the data clock signal CLK2 to the data driving part 740.

The compensating apparatus 800 photographs the image displayed on the display panel 710 and compensates the image. Specifically, the compensating apparatus 800 compensates a gamma difference of the image. The compensating apparatus 800 may include the gamma difference compensating apparatus 100 of FIG. 1 in order to compensate the gamma difference of the image. Thus, repetitive explanations concerning the compensating apparatus 800 will be omitted. In addition, the compensating apparatus 800 may further compensate a spot defect of the image displayed on the display panel 710.

According to the present exemplary embodiment, an offset gamma value which is a difference between a first gamma value of the left area and a front gamma value of the left area is applied to the first gamma curve data GCD1 generated based on the photograph data PD. In addition, an offset gamma value which is a difference between a first gamma value of the right area and a front gamma value of the right area is applied to the first gamma curve data GCD1 generated based on the photograph data PD. Therefore, after photographing an image displayed on a display panel using one camera, a gamma difference and a spot defect of the image may be compensated. Therefore, a luminance uniformity of the display panel may be increased, and display quality of a display apparatus including the display panel may be improved.

According to a gamma difference compensating apparatus, a method of compensating a gamma difference using the gamma difference compensating apparatus, and a display system including the gamma difference compensating apparatus, after photographing an image displayed on a display panel using one camera, a gamma difference and a spot defect of the image may be compensated. Therefore, a luminance uniformity of the display panel may be increased, display quality of a display apparatus including the display panel may be improved, and a manufacturing cost of an inspection apparatus inspecting the display apparatus may be decreased.

The foregoing is illustrative of the present inventive concept and is not to be construed as limiting thereof. Although a few exemplary embodiments of the present inventive concept have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. In the claims, means-plus-function clauses are intended to cover the structures described herein as performing the recited function and not only structural equivalents but also equivalent structures. Therefore, it is to be understood that the foregoing is illustrative of the present inventive concept and is not to be construed as limited to the specific exemplary embodiments disclosed, and that modifications to the disclosed exemplary embodiments, as well as other exemplary embodiments, are intended to be included within the scope of the appended claims. The present inventive concept is defined by the following claims, with equivalents of the claims to be included therein.

What is claimed is:

1. A gamma difference compensating apparatus comprising:
a photographing part configured to photograph an image displayed on a display panel and output a photograph data;
an average luminance calculating part configured to output an average luminance data of the image based on the photograph data;
a first gamma curve generating part configured to output a first gamma curve data of the image based on the average luminance data;
a front luminance measuring part configured to measure a luminance of a left area from a front of the left area disposed at a left side compared to a center area of the display panel, measure a luminance of a right area from a front of the right area disposed at a right side compared to the center area of the display panel, and output a front luminance data;
a front gamma calculating part configured to output a front gamma data based on the front luminance data;
a second gamma curve generating part configured to apply the front gamma data to the first gamma data and output a second gamma curve data; and
a gamma compensating part configured to compensate a gamma value of the left area and a gamma value of the right area such that the gamma value of the left area is the same as a gamma value of the center area and the gamma value of the right area is the same as the gamma value of the center area.

2. The gamma difference compensating apparatus of claim 1, wherein the second gamma curve generating part comprises:
an offset gamma calculating part configured to calculate a difference between a first gamma value of the left area included in the first gamma curve data and a front gamma value of the left area included in the front gamma data, calculate a difference between a first gamma value of the right area included in the first gamma curve data and a front gamma value of the right area included in the front gamma data, and output an offset gamma data; and
a gamma curve generating part configured to apply the offset gamma data to the first gamma curve data and output the second gamma curve data.

3. The gamma difference compensating apparatus of claim 2, wherein the photographing part photographs the center area including a middle center area focused by the photographing part, an upper center area adjacent to an upper side of the display panel compared to the middle center area and a lower center area adjacent to a lower side of the display panel compared to the middle center area, the left area including a middle left area adjacent to a left side of the display panel compared to the middle center area, an upper left area adjacent to the left side of the display panel compared to the upper center area and a lower left area adjacent to the left side of the display panel compared to the lower center area, and a middle right area adjacent to a right side of the display panel compared to the middle center area, an upper right area adjacent to the right side of the display panel compared to the upper center area and a lower right area adjacent to the right side of the display panel compared to the lower center area.

4. The gamma difference compensating apparatus of claim 3, wherein the first gamma curve generating part outputs a first middle center gamma value of the middle center area, a first upper center gamma value of the upper center area, a first lower center gamma value of the lower center area, a first middle left gamma value of the middle left area, a first upper left gamma value of the upper left area, a first lower left gamma value of the lower left area, a first middle right gamma value of the middle right area, a first upper right gamma value of the upper right area and a first lower right gamma value of the lower right area.

5. The gamma difference compensating apparatus of claim 4, wherein the front luminance measuring part outputs a middle left front luminance value of the middle left area, an upper left front luminance value of the upper left area, a lower left front luminance value of the lower left area, a middle right front luminance value of the middle right area, an upper right front luminance value of the upper right area and a lower right front luminance value of the lower right area.

6. The gamma difference compensating apparatus of claim 5, wherein the front gamma calculating part outputs a middle left front gamma value of the middle left area, an upper left front gamma value of the upper left area, a lower left front gamma value of the lower left area, a middle right front gamma value of the middle right area, an upper right front gamma value of the upper right area and a lower right front gamma value of the lower right area.

7. The gamma difference compensating apparatus of claim 6, wherein the offset gamma calculating part calculates a difference between the first middle left gamma value of the middle left area and the middle left front gamma value of the middle left area to output a middle left offset gamma value of the middle left area, calculates a difference between the first upper left gamma value of the upper left area and the upper left front gamma value of the upper left area to output an upper left offset gamma value of the upper left area, calculates a difference between the first lower left gamma value of the lower left area and the lower left front gamma value of the lower left area to output a lower left offset gamma value of the lower left area, calculates a difference between the first middle right gamma value of the middle right area and the middle right front gamma value of the middle right area to output a middle right offset gamma value of the middle right area, calculates a difference between the first upper right gamma value of the upper right area and the upper right front gamma value of the upper right area to output an upper right offset gamma value of the upper right area, and calculates a difference between the first lower right gamma value of the lower right area and the lower right front gamma value of the lower right area to output a lower right offset gamma value of the lower right area.

8. The gamma difference compensating apparatus of claim 7, wherein the second gamma curve generating part applies the middle left offset gamma value of the middle left area to the first middle left gamma value of the middle left area to output a second middle left gamma value of the middle left area, applies the upper left offset gamma value of the upper left area to the first upper left gamma value of the upper left area to output a second upper left gamma value of the upper left area, applies the lower left offset gamma value of the lower left area to the first lower left gamma value of the lower left area to output a second lower left gamma value of the lower left area, applies the middle right offset gamma value of the middle right area to the first middle right gamma value of the middle right area to output a second middle right gamma value of the middle right area, applies the upper right offset gamma value of the upper right area to the first upper right gamma value of the upper right area to output a second upper right gamma value of the upper right area, and applies the lower right offset gamma value of the lower right area to the first lower right gamma value of the lower right area to output a second lower right gamma value of the lower right area.

9. The gamma difference compensating apparatus of claim 8, wherein the gamma compensating part compensates the second middle left gamma value of the middle left area such that the second middle left gamma value of the middle left area is the same as the first middle center gamma value of the middle center area, compensates the second upper left gamma value of the upper left area such that the second upper left gamma value of the upper left area is the same as the first upper center gamma value of the upper center area, compensates the second lower left gamma value of the lower left area such that the second lower left gamma value of the lower left area is the same as the first lower center gamma value of the lower center area, compensates the second middle right gamma value of the middle right area such that the second middle right gamma value of the middle right area is the same as the first middle center gamma value of the middle center area, compensates the second upper right gamma value of the upper right area such that the second upper right gamma value of the upper right area is the same as the first upper center gamma value of the upper center area, and compensates the second lower right gamma value of the lower right area such that the second lower right gamma value of the lower right area is the same as the first lower center gamma value of the lower center area.

10. A method of compensating a gamma difference, the method comprising:
photographing an image displayed on a display panel to output a photograph data;
outputting an average luminance data of the image based on the photograph data;
outputting a first gamma curve data of the image based on the average luminance data;
measuring a luminance of a left area from a front of the left area disposed at a left side compared to a center area of the display panel and measuring a luminance of a right area from a front of the right area disposed at a right side compared to the center area of the display panel to output a front luminance data;
outputting a front gamma data based on the front luminance data;
applying the front gamma data to the first gamma data to output a second gamma curve data; and
compensating a gamma value of the left area and a gamma value of the right area such that the gamma value of the left area is the same as a gamma value of the center area and the gamma value of the right area is the same as the gamma value of the center area.

11. The method of claim 10, wherein the generating the second gamma curve data comprises:
calculating a difference between a first gamma value of the left area included in the first gamma curve data and a front gamma value of the left area included in the front gamma data and calculating a difference between a first gamma value of the right area included in the first gamma curve data and a front gamma value of the right area included in the front gamma data to output an offset gamma data; and
applying the offset gamma data to the first gamma curve data to output the second gamma curve data.

12. The method of claim 11, wherein the photographing the image comprises photographing the center area including a middle center area focused by a photographing part, an upper center area adjacent to an upper side of the display panel compared to the middle center area and a lower center area adjacent to a lower side of the display panel compared to the middle center area, the left area including a middle left area adjacent to a left side of the display panel compared to the middle center area, an upper left area adjacent to the left side of the display panel compared to the upper center area and a lower left area adjacent to the left side of the display panel compared to the lower center area, and a middle right area adjacent to a right side of the display panel compared to the middle center area, an upper right area adjacent to the right side of the display panel compared to the upper center area and a lower right area adjacent to the right side of the display panel compared to the lower center area, using the photographing part.

13. The method of claim 12, wherein the outputting the first gamma curve data comprises:
outputting a first middle center gamma value of the middle center area;
outputting a first upper center gamma value of the upper center area;
outputting a first lower center gamma value of the lower center area;
outputting a first middle left gamma value of the middle left area;
outputting a first upper left gamma value of the upper left area;
outputting a first lower left gamma value of the lower left area;
outputting a first middle right gamma value of the middle right area;
outputting a first upper right gamma value of the upper right area; and
outputting a first lower right gamma value of the lower right area.

14. The method of claim 13, wherein the outputting the front luminance data comprises:
outputting a middle left front luminance value of the middle left area;
outputting an upper left front luminance value of the upper left area;
outputting a lower left front luminance value of the lower left area;
outputting a middle right front luminance value of the middle right area;
outputting an upper right front luminance value of the upper right area; and
outputting a lower right front luminance value of the lower right area.

15. The method of claim 14, wherein the outputting the front gamma data comprises:
outputting a middle left front gamma value of the middle left area;
outputting an upper left front gamma value of the upper left area;
outputting a lower left front gamma value of the lower left area;
outputting a middle right front gamma value of the middle right area;
outputting an upper right front gamma value of the upper right area; and
outputting a lower right front gamma value of the lower right area.

16. The method of claim 15, wherein the outputting the offset gamma data comprises:
calculating a difference between the first middle left gamma value of the middle left area and the middle left front gamma value of the middle left area to output a middle left offset gamma value of the middle left area;
calculating a difference between the first upper left gamma value of the upper left area and the upper left front gamma value of the upper left area to output an upper left offset gamma value of the upper left area;
calculating a difference between the first lower left gamma value of the lower left area and the lower left front gamma value of the lower left area to output a lower left offset gamma value of the lower left area;
calculating a difference between the first middle right gamma value of the middle right area and the middle right front gamma value of the middle right area to output a middle right offset gamma value of the middle right area;
calculating a difference between the first upper right gamma value of the upper right area and the upper right front gamma value of the upper right area to output an upper right offset gamma value of the upper right area; and
calculating a difference between the first lower right gamma value of the lower right area and the lower right front gamma value of the lower right area to output a lower right offset gamma value of the lower right area.

17. The method of claim 16, wherein the outputting the second gamma curve data comprises:
applying the middle left offset gamma value of the middle left area to the first middle left gamma value of the middle left area to output a second middle left gamma value of the middle left area;
applying the upper left offset gamma value of the upper left area to the first upper left gamma value of the upper left area to output a second upper left gamma value of the upper left area;
applying the lower left offset gamma value of the lower left area to the first lower left gamma value of the lower left area to output a second lower left gamma value of the lower left area;
applying the middle right offset gamma value of the middle right area to the first middle right gamma value of the middle right area to output a second middle right gamma value of the middle right area;
applying the upper right offset gamma value of the upper right area to the first upper right gamma value of the upper right area to output a second upper right gamma value of the upper right area; and
applying the lower right offset gamma value of the lower right area to the first lower right gamma value of the lower right area to output a second lower right gamma value of the lower right area.

18. The method of claim 17, wherein the compensating the gamma value comprises:
compensating the second middle left gamma value of the middle left area such that the second middle left gamma value of the middle left area is the same as the first middle center gamma value of the middle center area;
compensating the second upper left gamma value of the upper left area such that the second upper left gamma value of the upper left area is the same as the first upper center gamma value of the upper center area;
compensating the second lower left gamma value of the lower left area such that the second lower left gamma value of the lower left area is the same as the first lower center gamma value of the lower center area;
compensating the second middle right gamma value of the middle right area such that the second middle right gamma value of the middle right area is the same as the first middle center gamma value of the middle center area;
compensating the second upper right gamma value of the upper right area such that the second upper right gamma value of the upper right area is the same as the first upper center gamma value of the upper center area; and
compensating the second lower right gamma value of the lower right area such that the second lower right gamma value of the lower right area is the same as the first lower center gamma value of the lower center area.

19. A display system comprising:
a display apparatus comprising a display panel including a gate line and a data line and displaying an image, a gate driving part outputting a gate signal to the gate line, and a data driving part outputting a data signal to the data line; and
a compensating apparatus comprising a photographing part photographing the image displayed on the display panel to output a photograph data, an average luminance calculating part outputting an average luminance data of the image based on the photograph data, a first gamma curve generating part outputting a first gamma curve data of the image based on the average luminance data, a front luminance measuring part measuring a luminance of a left area from a front of the left area disposed at a left side compared to a center area of the display panel and measuring a luminance of a right area from a front of the right area disposed at a right side compared to the center area of the display panel to output a front luminance data, a front gamma calculating part outputting a front gamma data based on the front luminance data, a second gamma curve generating part applying the front gamma data to the first gamma data to output a second gamma curve data, and a gamma compensating part compensating a gamma value of the left area and a gamma value of the right area such that the gamma value of the left area is the same as a gamma value of the center area and the gamma value of the right area is the same as the gamma value of the center area.

20. The display system of claim 19, wherein the compensating apparatus further compensates a spot defect of the image.
